(19) United States
(12) Patent Application Publication
(10) Pub. No.: US 2005/0261092 A1
(43) Pub. Date: Nov. 24, 2005

(54) Power transmission device of compressor

(75) Inventors: Yoshihiro Ochiai, Isesaki-shi (JP); Atsushi Ozawa, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/130,189

(22) Filed: May 17, 2005

(30) Foreign Application Priority Data
May 18, 2004 (JP) 2004/148009

(51) Int. Cl. F16H 55/36; F16H 63/00; F16H 61/00

(52) U.S. Cl. 474/70; 474/199

(57) ABSTRACT

The present invention provides a power transmission device of a compressor that can always transmit power satisfactorily without transmitting a rotation number fluctuation applied from a power source to a pulley to a transmission member. Specifically, a one-way clutch is provided between the pulley and a torque plate, thereby allowing torque in one direction only of the pulley to be transmitted to the torque plate. Therefore, even if power from a power source such as an internal combustion engine in which the rotation number fluctuates in a short cycle is transmitted to the pulley, torque at the time of reduction in the rotation number is not transmitted to the torque plate, and inertial torque of a rotation component of the compressor produced by the reduction in the rotation number is reduced to reduce vibration or noise of the compressor. The one-way clutch is placed between a pulley body and a support portion, thereby reducing an axial size of the entire power transmission device to save space.

### BACKGROUND OF THE INVENTION

(i) Field of the Invention

The present invention relates to a power transmission device of a compressor that transmits power from a drive source of a vehicle to a compressor used in a vehicle air conditioning device.

(ii) Description of the Related Art

A known power transmission device of such a type includes a pulley rotated by power from a power source, a transmission member rotated by the pulley, and a hub connected to the transmission member via a torque limiter, and is adapted so that a shock absorbing rubber is placed between the pulley and the transmission member to absorb a shock such as a torque fluctuation transmitted to the pulley and transmit torque to the transmission member.

In the power transmission device, however, a rotation number fluctuation in a short cycle that occurs when the power source is an internal combustion engine cannot be absorbed by the shock absorbing rubber. Thus, the rotation number fluctuation in the short cycle in the power source increases inertial torque of a rotation component of a compressor connected to the hub. This may increase vibration and noise of the compressor to cause a fault of the compressor.

### SUMMARY OF THE INVENTION

The present invention has an object to provide a power transmission device of a compressor that can always transmit power satisfactorily without transmitting a rotation number fluctuation applied from a power source to a pulley to a transmission member.

In order to achieve the object, the present invention provides a power transmission device of a compressor, comprising: a drive rotor having a body portion to which external power is transmitted, a support portion rotatably supported at one axial end of the compressor, and a connecting portion for connecting one axial ends of the body portion and the support portion; a driven rotor for transmitting a torque of the drive rotor to a rotation axis of the compressor; and a one-way clutch provided between the body portion and the support portion of the drive rotor for transmitting torque in one direction only of the drive rotor to the driven rotor.

This allows the torque in one direction only of the drive rotor to be transmitted to the driven rotor, and even if power from a power source in which the rotation number fluctuates in a short cycle is transmitted to the drive rotor, torque at the time of reduction in the rotation number is not transmitted. Therefore, even if power from a power source such as an internal combustion engine in which the rotation number fluctuates in a short cycle is transmitted to the drive rotor, torque at the time of reduction in the rotation number is not transmitted to the driven rotor, and inertial torque of a rotation component of the compressor produced by the reduction in the rotation number is reduced to reduce vibration or noise of the compressor. The one-way clutch is placed between the body portion and the support portion, thereby reducing an axial size of the entire power transmission device to save space.

The foregoing and other objects, features, and advantages of the present invention will become more apparent from the following description with reference to the accompanying drawings.

### BRIEF DESCRIPTION OF THE DRAWINGS

FIG. 1 is a side sectional view of a power transmission device of a compressor according to an embodiment of the present invention;

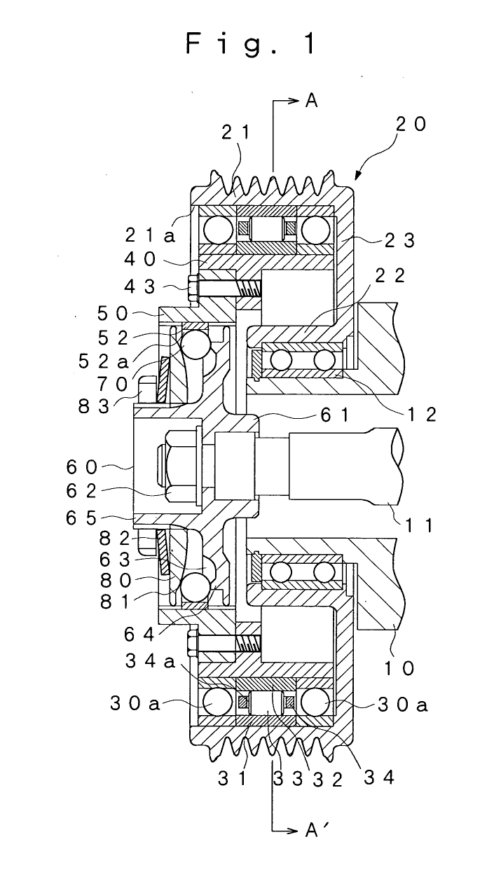

FIG. 2 is a sectional view taken along the line A-A′ in FIG. 1;

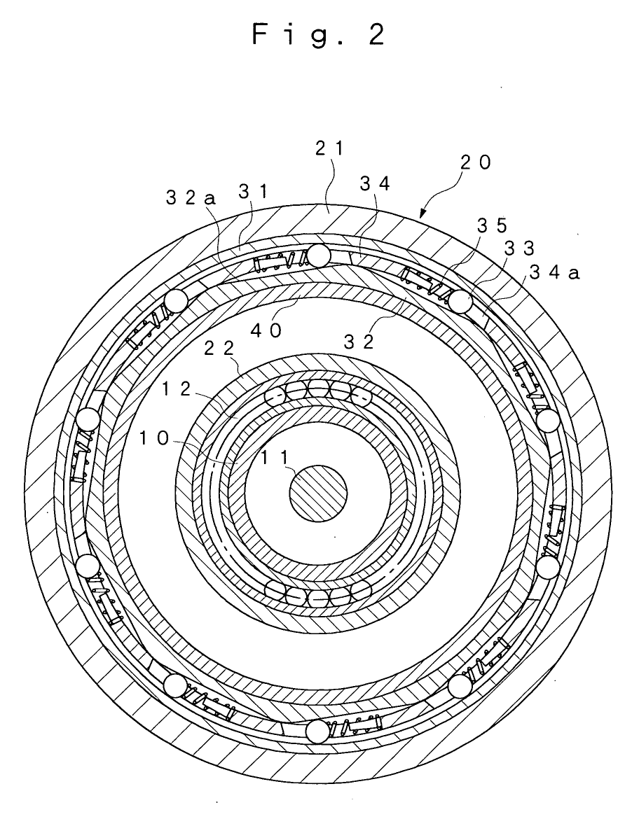

FIG. 3 is an exploded side sectional view of the power transmission device;

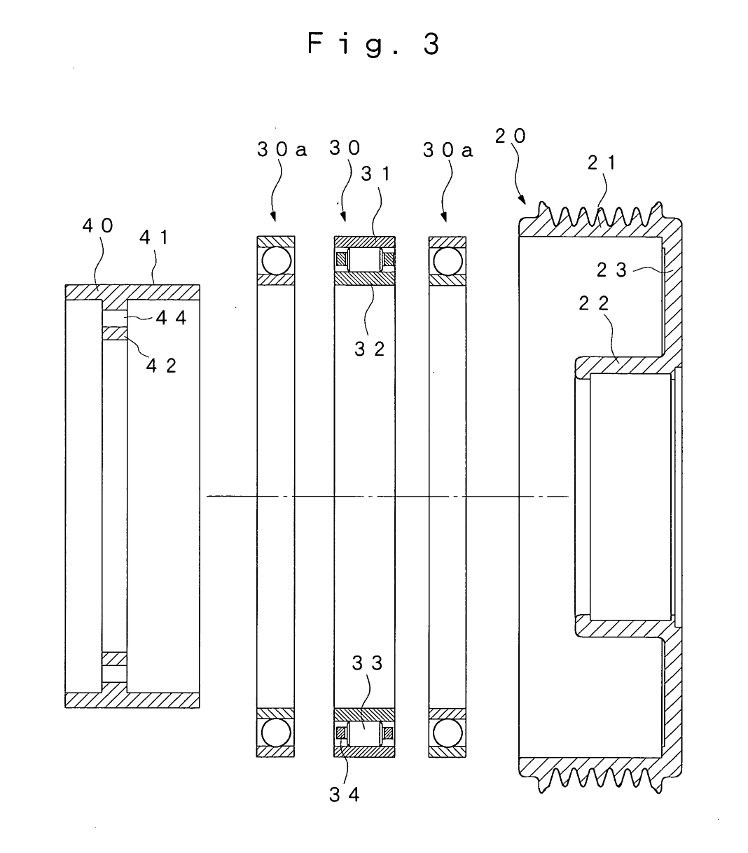

FIG. 4 is an exploded side sectional view of the power transmission device;

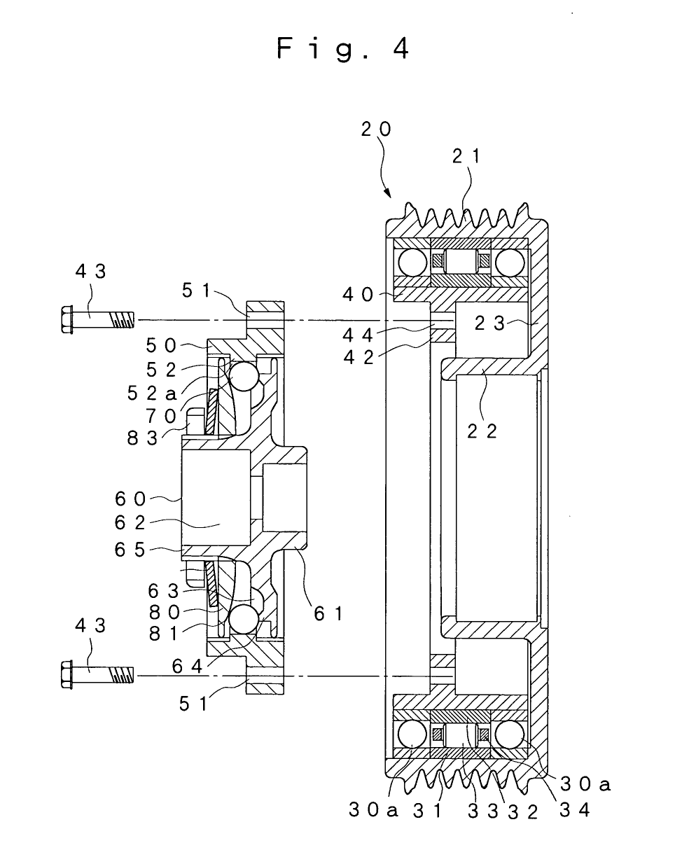

FIG. 5 is a side sectional view of the power transmission device showing a state of interruption of power transmission;

FIG. 6 is a side sectional view of a power transmission device of a compressor according to another embodiment;

FIG. 7 is a front sectional view of a pulley and a one-way clutch in which the pulley is molded of synthetic resin with the one-way clutch being assembled;

FIG. 8 is a side sectional view of the pulley and the one-way clutch in which the pulley is molded of synthetic resin with the one-way clutch being assembled; and

FIG. 9 is a side sectional view of a power transmission device including a one-way clutch and a connection member integrally formed.

### DESCRIPTION OF THE PREFERRED EMBODIMENTS

A power transmission device of a compressor includes a housing 10 as a compressor body, a pulley 20 as a drive rotor to which torque is transmitted from a power source, a one-way clutch 30 for transmitting torque in one direction only of the pulley 20, a connection ring 40 as a connection member to which the torque of the pulley 20 is transmitted via the one-way clutch 30, a torque plate 50 as a driven rotor connected to the connection ring 40 and to which the torque of the pulley 20 is transmitted, a hub 60 as a driven rotor for transmitting torque of the torque plate 50 to a rotation axis 11 of the compressor, a plurality of balls 70 for transmitting the torque of the torque plate 50 to the hub 60, and a pressing ring 80 for axially pressing each ball 70.

The housing 10 is formed of a cylindrical member, and is adapted so that torque is transmitted to the rotation axis 11 protruding from one end to rotate an unshown compression mechanism in the compressor.

The pulley 20 includes a pulley body 21 as a body portion that is formed on an outer peripheral side and around which an unshown power transmission belt is wound, a support portion 22 that is formed on an inner peripheral side and rotatably supported by a bearing 12 provided in the housing 10, and a connecting portion 23 that circumferentially connects one axial ends of the pulley body 21 and the support portion 22, and is placed coaxially with the rotation axis 11. A securing surface 21a to which the one-way clutch 30 is securable is formed in an inner peripheral surface of the pulley body 21.

The one-way clutch 30 is secured by an outer peripheral surface thereof being pressed into the securing surface 21a, and an inner peripheral surface thereof being pressed into an outer peripheral surface of the connection ring 40. Bearings 30a are placed at both axial ends of the one-way clutch. The one-way clutch 30 includes an outer peripheral ring 31 secured to the pulley 20, an inner peripheral ring 32 secured to the connection ring 40, a plurality of rollers 33 provided between the outer peripheral ring 31 and the inner peripheral ring 32, a holding ring 34 for holding the rollers 33, and a plurality of coil springs 35 for urging the rollers 33 in a direction of connecting the outer peripheral ring 31 and the inner peripheral ring 32. A plurality of planes 32a are provided in an outer peripheral surface of the inner peripheral ring 32 by forming an axial section in a polygonal shape. A plurality of holding portions 34a that can hold the rollers 33 in a circumferentially spaced-apart manner are provided in the holding ring 34. Specifically, each roller 33 is placed in the holding portion 34a of the holding ring 34 between each plane 32a of the inner peripheral ring 32 and an inner peripheral surface of the outer peripheral ring 31. At this time, a distance in a diametrical direction between each plane 32a of the inner peripheral ring 32 and the inner peripheral surface of the outer peripheral ring 31 becomes smaller toward both circumferential ends of each plane 32a. The distance in the diametrical direction between the both circumferential ends of each plane 32a and the inner peripheral surface of the outer peripheral ring 31 is smaller than a diameter of the roller 33. Further, in the holding portion 34a of the holding ring 34, the coil spring 35 that urges the roller 33 toward one circumferential end is secured to the other circumferential end in the holding portion 34a.

The connection ring 40 is formed of a cylindrical member, and secured by an outer peripheral surface 41 being pressed into the inner peripheral surface of the inner peripheral ring 32 of the one-way clutch 30. A securing piece 42 for securing the torque plate 50 is formed in an inner peripheral surface of the connection ring 40 so as to extend inward in a diametrical direction. A plurality of mounting holes 44 into which mounting bolts 43 are screwed are provided in the securing piece 42 in a circumferentially spaced-apart manner.

A plurality of mounting holes 51 are provided in an outer side of the torque plate 50 in the diametrical direction in a circumferentially spaced-apart manner. The torque plate 50 is secured by the mounting bolts 43 being inserted into the mounting holes 51 and screwed into the mounting holes 44 in the connection ring 40. Also, a locking ring 52 that locks each ball 70 from outside in the diametrical direction is mounted to an inner peripheral surface of the torque plate 50. A plurality of taper surfaces 52a that form a predetermined angle between adjacent ones are formed in an inner peripheral surface of the locking ring 52a. Each ball 70 abuts against an adjacent taper surface 52a and is placed outside in the diametrical direction.

The hub 60 is formed into a disk shape, and is placed on the side of the inner peripheral surface of the torque plate 50. A connecting portion 61 to which the rotation axis 11 is connected is provided in one end surface of the hub 60. The rotation axis 11 is secured to the hub 60 by a nut 62 screwed in the other end surface of the hub 60. A plurality of ball grooves 63 that engage the balls 70 movably in the diametrical direction are provided in the other end surface of the hub 60 in a circumferentially spaced-apart manner, and each ball 70 is circumferentially locked in an outside surface of the ball groove 63 in the diametrical direction. In this case, a protrusion 64 protruding axially is provided outside the ball groove 63 in the diametrical direction, and the protrusion 64 axially abuts against the ball 70 placed outside the ball groove 63 in the diametrical direction. An extending portion 65 extending axially in a tubular shape so as to cover the nut 62 is provided in the center in the diametrical direction of the other end surface of the hub 60.

The pressing ring 80 engages the extending portion 65 of the hub 60 movably in the axial direction. One end of the pressing ring 80 abuts against each ball 70. An inclined surface 81 gradually axially protruding from outside to inside in the diametrical direction is provided in one end surface of the pressing ring 80. The ball 70 placed outside the ball groove 63 in the diametrical direction abuts against the outside of the inclined surface 81 in the diametrical direction. A Belleville spring 82 that engages the extending portion 65 of the hub 60 is provided in the other end surface of the pressing ring 80. The Belleville spring 82 urges the pressing ring 80 toward the ball 70. The Belleville spring 82 is placed in a compressed state between an annular nut 83 that screws over the extending portion 65 and the pressing ring 80. Adjusting a fastening force of the nut 83 allows a pressing force of the pressing ring 80 by the Belleville spring 82 to be freely set.

In the power transmission-device of the compressor thus configured, when the power from the power source is transmitted to the pulley 20, the outer peripheral ring 31 of the one-way clutch 30 rotates integrally with the pulley 20. At this time, the one-way clutch 30 transmits the torque in one circumferential direction. When the rotation number of the pulley 20 increases, each roller 33 of the one-way clutch 30 is rolled on the plane 32a of the inner peripheral ring 32 toward one circumferential end by rotation of the outer peripheral ring 31. The distance in the diametrical direction between each plane 32a of the inner peripheral ring 32 and the inner peripheral surface of the outer peripheral ring 31 becomes smaller toward the both circumferential ends of each plane 32a, and thus each roller 33 is locked between the inner peripheral surface of the outer peripheral ring 31 and each plane 32a of the inner peripheral ring 32. This causes the outer peripheral ring 31 and the inner peripheral ring 32 to be connected. When the rotation number of the pulley 20 abruptly decreases, the outer peripheral ring 31 of the one-way clutch 30 applies torque toward the other circumferential side with respect to the inner peripheral ring 32. Thus, each roller 33 of the one-way clutch 30 are rolled on the plane 32a of the inner peripheral ring 32 toward the other circumferential end against the urging force of the coil spring 35 by a difference in angular speed between the outer peripheral ring 31 and the inner peripheral ring 32. Thus, the outer peripheral ring 31 and the inner peripheral ring 32 are disconnected to interrupt transmission of the torque from the pulley 20 to the inner peripheral ring 32. Therefore, the torque in one circumferential direction of the pulley 20 is transmitted to the torque plate 50 via the one-way clutch 30 and the connection ring 40. The torque transmitted to the torque plate 50 is transmitted to the hub 60 via the locking ring 52 and the ball 70, and the rotation axis 11 of the compressor rotates together with the hub 60. At this time, each ball 70 is pressed outward of each ball groove 63 in the diametrical direction by the inclined surface 81 of the pressing ring 80, and each ball 70 is circumferentially locked by the taper surface 52a of the locking ring 52, thereby causing the torque of the torque plate 50 to be transmitted to the hub 60.

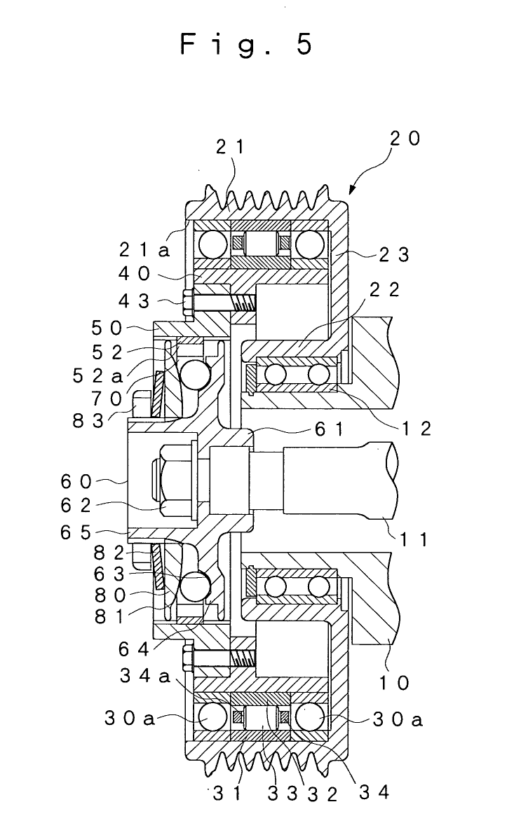

If an excessive rotation load is applied to the pulley 20 because of, for example, seizing of the compressor, the press of the taper surface 52a of the locking ring 52 causes each ball 70 to be moved inward of the ball groove 63 in the diametrical direction against the pressing force of the pressing ring 80 as shown in FIG. 5. Thus, each ball 70 is held inside the ball groove 63 in the diametrical direction by the protrusion 64 of the ball groove 63 and the pressing ring 80, and the ball 70 is restrained in a position where the ball 70 cannot be locked by the locking ring 52. This causes idling of the torque plate 50 with respect to the hub 60, and power transmission from the pulley 20 to the drive shaft 11 is interrupted.

Thus, according to the power transmission device of the compressor of the embodiment, the one-way clutch 30 is provided between the pulley 20 and the torque plate 50, thereby allowing the torque in one direction only of the pulley 20 to be transmitted to the torque plate 50. Therefore, even if power from a power source such as an internal combustion engine in which the rotation number fluctuates in a short cycle is transmitted to the pulley 20, torque at the time of reduction in the rotation number is not transmitted to the torque plate 50. Inertial torque of a rotation component of the compressor produced by the reduction in the rotation number is reduced to reduce vibration or noise of the compressor. The one-way clutch 30 is placed between the pulley body 21 and the support portion 22, thereby reducing an axial size of the entire power transmission device and providing a compact device.

The outer peripheral ring 31 of the one-way clutch 30 is secured by being pressed into the securing surface 21a of the pulley body 21 of the pulley 20, thereby allowing the one-way clutch 30 to be secured to the pulley 20 without the need for a separate securing member. This reduces the number of components.

The one-way clutch 30 and the torque plate 50 are connected by the connection ring 40, thereby allowing a different torque plate to be mounted by changing the connection ring 40. This facilitates a change of a power interruption mechanism.

The one-way clutch 30 is secured by being pressed into the outer peripheral surface 41 of the connection ring 40, thereby allowing the one-way clutch 30 to be secured to the connection ring 40 without the need for a separate securing member. This reduces the number of components.

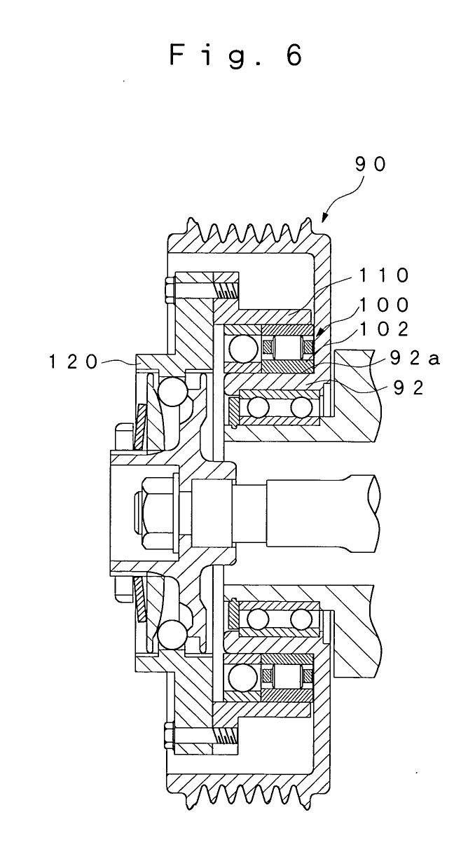

In the embodiment, the pulley 20 and the torque plate 50 are connected by pressing the outer peripheral ring 31 of the one-way clutch 30 into the securing surface 21a on the inner peripheral side of the pulley body 21 of the pulley 20, and pressing the outer peripheral surface 41 of the connection ring 40 into the inner peripheral ring 32 of the one-way clutch 30, but as shown in FIG. 6, the same advantage can be obtained by connecting a pulley 90 and a torque plate 120 by forming a securing surface 92a in an outer peripheral surface of a support portion 92 of the pulley 90 to press an inner peripheral ring 102 of a one-way clutch 100 into the securing surface 92a, and pressing an inner peripheral surface of a connection ring 110 into an outer peripheral ring 101 of the one-way clutch 100.

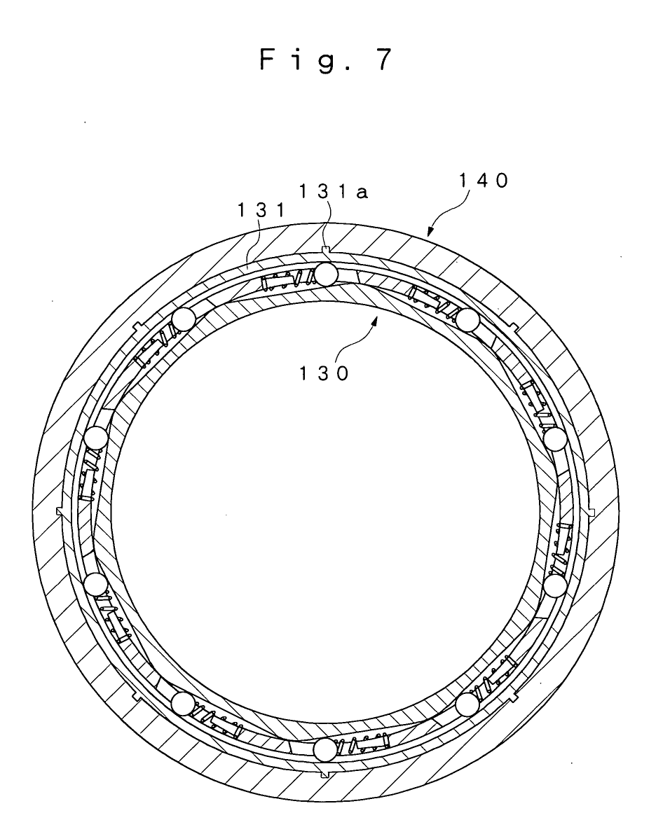

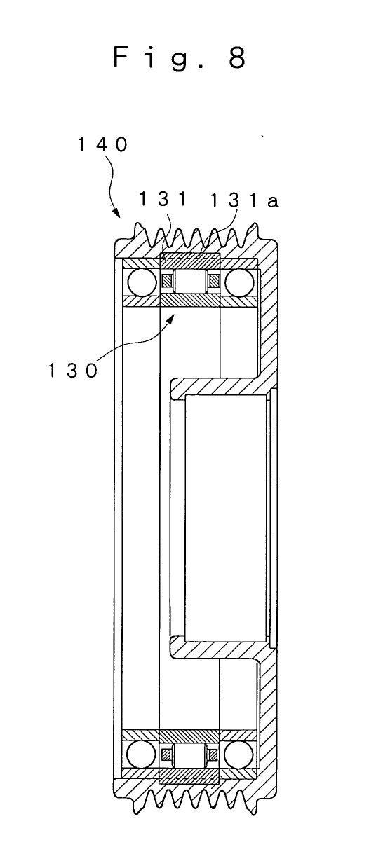

In the embodiment, the outer peripheral ring 31 of the one-way clutch 30 is pressed into the inner peripheral surface of the pulley body 21 of the pulley 20, but as shown in FIGS. 7 and 8, at least one engagement portion 131a for circumferential engagement with the pulley 140 may be provided an outer peripheral surface of an outer peripheral ring 131 of a one-way clutch 130, and a pulley 140 may be molded of synthetic resin with the one-way clutch 130 being placed.

In this case, the pulley 140 is made of synthetic resin, and thus can be easily machined, thereby reducing costs.

Also, the pulley 140 is molded of synthetic resin with the one-way clutch 130 being placed, and thus the pulley 140 and the one-way clutch 130 can be handled as one component without being assembled in an assembling process, thereby reducing the number of assembling steps.

Further, at least one engagement portion 131a for circumferential engagement with the pulley 140 is provided the outer peripheral surface of the outer peripheral ring 131 of the one-way clutch 130, thereby preventing circumferential slips of the one-way clutch 130 and the pulley 140 and ensuring transmission of the torque transmitted to the pulley 140 to the torque plate 50.

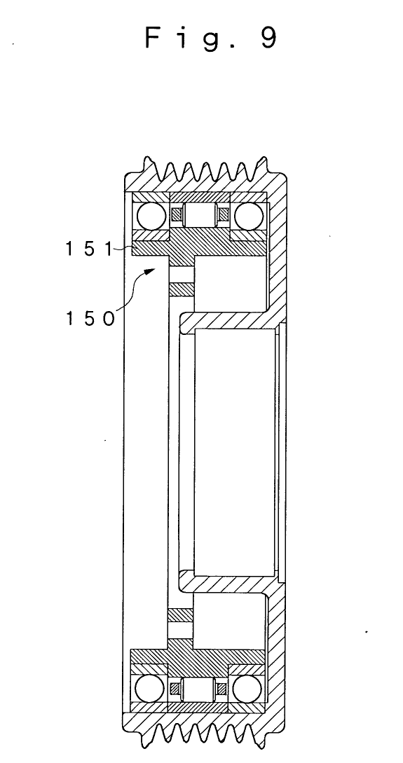

In the embodiment, the outer peripheral surface of the connection ring 40 is pressed into the inner peripheral ring 32 of the one-way clutch 30, but as shown in FIG. 9, an inner peripheral ring 151 of a one-way clutch 150 and a connection ring may be integrally formed without a connection ring 40 as a separate member. In this case, the one-way clutch 150 and the connection ring can be handled as one component, thereby reducing the number of assembling steps.

In the embodiment, a power interruption mechanism is provided that transmits the power of the torque plate 50 to the hub 60 by locking the plurality of balls 70 movably in the diametrical direction to the torque plate 50, and moves each ball 70 in the diametrical direction of the hub 60 to unlock the ball 70 from the torque plate 50 when torque equal to or higher than a predetermined value occurs between the torque plate 50 and the hub 60. However, a power interruption mechanism may be provided that transmits torque of a torque plate to a hub by causing at least one engagement portion provided in one of the torque plate and the hub to engage the other of the torque plate and the hub, and breaks the engagement portion by a circumferential shearing force of the hub to disengage the engagement portion from the torque plate when torque equal to or higher than a predetermined value occurs between the torque plate and the hub.

The preferred embodiment in the specification is illustrated by way of example, and not by way of limitation. The scope of the invention is defined by the appended claim, and the invention covers all modifications that falls within the meaning of the claim.

1. A power transmission device of a compressor, comprising:
a drive rotor having a body portion to which external power is transmitted, a support portion rotatably supported at one axial end of the compressor, and a connecting portion for connecting one axial ends of the body portion and the support portion;
a driven rotor for transmitting a torque of the drive rotor to a rotation axis of the compressor; and
a one-way clutch provided between the body portion and the support portion of the drive rotor for transmitting torque in one direction only of the drive rotor to the driven rotor.

2. The power transmission device according to claim 1, wherein:
said one-way clutch is placed between an inner peripheral surface of the body portion of the drive rotor and an outer peripheral surface of the driven rotor.

3. The power transmission device according to claim 1, wherein:
said one-way clutch is placed between an outer peripheral surface of the support portion of the drive rotor and an inner peripheral surface of the driven rotor.

4. The power transmission device according to claim 2, wherein:
said one-way clutch is secured by being pressed into one or both of the drive rotor and the driven rotor.

5. The power transmission device according to claim 3, wherein:
said one-way clutch is secured by being pressed into one or both of the drive rotor and the driven rotor.

6. The power transmission device according to claim 2, wherein:
said drive rotor is molded of synthetic resin with the one-way clutch being assembled.

7. The power transmission device according to claim 3, wherein:
said drive rotor is molded of synthetic resin with the one-way clutch being assembled.

8. The power transmission device according to claim 6, wherein:
at least one engagement portion for circumferential engagement with the drive rotor is formed in said one-way clutch.

9. The power transmission device according to claim 7, wherein:
at least one engagement portion for circumferential engagement with the drive rotor is formed in said one-way clutch.

10. The power transmission device according to claim 2, further comprising:
a connection member for connecting a member of an inner peripheral side of said one-way clutch and the driven rotor.

11. The power transmission device according to claim 3, further comprising:
a connection member for connecting a member of an outer peripheral side of said one-way clutch and the driven rotor.

12. The power transmission device according to claim 10, wherein:
said one-way clutch is secured by being pressed into the connection member.

13. The power transmission device according to claim 11, wherein:
said one-way clutch is secured by being pressed into the connection member.

14. The power transmission device according to claim 10, wherein:
said one-way clutch is integrally formed with the connection member.

15. The power transmission device according to claim 11, wherein:
said one-way clutch is integrally formed with the connection member.

16. The power transmission device according to claim 10, wherein:
said driven rotor is connected to the connection member by a bolt.

17. The power transmission device according to claim 11, wherein:
said driven rotor is connected to the connection member by a bolt.

18. A power transmission device of a compressor, comprising:
a drive rotor that has a body portion to which external power is transmitted, a support portion rotatably supported at one axial end of the compressor body, and a connecting portion that connects one axial ends of the body portion and the support portion;
a driven rotor that transmits the torque of the drive rotor to a rotation axis of the compressor; and
a one-way clutch that is provided between the body portion and the support portion of the drive rotor and that transmits torque in one direction only of the drive rotor to the driven rotor.
